(19) United States
(12) Patent Application Publication
(10) Pub. No.: US 2007/0003280 A1
(43) Pub. Date: Jan. 4, 2007

(54) Method and system for determining receiver power for required bit error rate

(76) Inventors: Gilberto I. Sada, Irvine, CA (US); Maurice M. Reintjes, Beaverton, OR (US); Ken Feldhaus, Hillsboro, OR (US); John Comeau, New York, NY (US)

Correspondence Address: AKIN GUMP STRAUSS HAUER & FELD, LLP, P O BOX 688, DALLAS, TX, 75313-0688, US

(21) Appl. No.: 11/107,394

(22) Filed: Apr. 15, 2005

(51) Int. Cl. H04B 10/08

(52) U.S. Cl. 398/27

(57) ABSTRACT

A method and system for determining a receiver power for a required bit error rate (BER) in an optical communication systems is disclosed. A signal is transmitted using an initial transmitter power and is received at a receiver. A BER contour diagram is created by measuring high BER values and approximating low BER values from the high BER values. The optimum decision threshold and/or sampling phase is determined from the contour diagram and the BER is calculated at the optimum decision threshold and/or at the optimum sampling phase. If the calculated BER is not close to or equal to the required BER, the transmitter power is adjusted until the calculated BER is close to or equal to the required BER. The receiver power is then calculated from the transmitter power or directly measured from the received signal.

### RELATED APPLICATION

This application is related to an application entitled “BIT ERROR RATE CONTOUR-BASED OPTIMUM DECISION THRESHOLD AND SAMPLING PHASE SELECTION”, attorney docket number 185940/US, filed concurrently.

### TECHNICAL FIELD

The present invention relates generally to optical communication systems, and more specifically to a method and system for determining receiver power for a required bit error rate (BER).

### BACKGROUND OF THE INVENTION

In optical communication systems, it is often desirable to determine the minimum power at a receiver to achieve a required or a specified bit error rate (or bit error ratio, where the bit error ratio is defined as the number of erroneously transmitted bits divided by the number of correct bits). Many optical communication systems must operate within a specified BER. The BER is generally dependent, among others, on the receiver power. The BER decreases as the receiver power is increased and the BER increases as the receiver power is decreased. The BER is a measure of an optical communication system's performance and reliability. A low BER generally indicates superior system performance while a high BER indicates inferior system performance.

FIG. 1 illustrates a block diagram of an optical communication system 100. The system 100 includes a signal source 104 that generates a source signal Ss 105.

The source signal Ss 105 is a digital signal having a binary data stream.

The signal Ss 105 is received by an optical transmitter 108 that converts the signal Ss 105 into an optical signal So 109. The signal So 109 is transmitted over a fiber channel 112 to an optical receiver 116. The optical receiver 116 converts the optical signal So 109 into an electrical signal Sr 117.

If C_{S} represents the number of bits in S_{S} and C_{RE} represents the number of error bits in S_{R}, then, BER can be defined by the following equation:

$$BER = \frac{{C}_{RE}}{{C}_{S}} . \qquad ( 1 )$$

Where C_{RE} is defined as

$${C}_{RE} = {\sum }_{n = 1}^{N} \vert {S}_{S} ( n ) - {S}_{R} ( n ) \vert . \qquad ( 2 )$$

And where S_{S}(n) represents the nth bit of the signal Ss and S_{R}(n) represents the nth bit of signal received by a BER tester 120 shown in FIG. 1.

In addition to the receiver power, the BER is dependent on the sampling phase and decision threshold at the receiver. The relationship of the BER to the sampling phase and the decision threshold is represented by a BER contour diagram. A BER contour diagram is created by measuring a plurality of BERs for various values of sampling phases and decision thresholds. The measured sampling phases and decision thresholds corresponding to a common BER is plotted to create the BER contour diagram.

A sampling phase indicates where in time a signal is sampled. For example, an optical signal may have a pulse width of 10 ns. The optical signal may be sampled 1 ns, 0.1 ns or at any other arbitrary time less than 10 ns from the origin of the pulse.

A decision threshold is a numerical value used to determine if the sampled bit is a mark (i.e., “1”) or a space (i.e., “0”). For example, if the decision threshold is 0.7, then sampled values greater than 0.7 are considered marks and sampled values less than 0.7 are considered spaces.

A plurality of BER contours are used to create a BER contour diagram. FIG. 2 is a BER contour diagram that includes a plurality of BER contours. Each contour in the diagram represents a specific BER value. In FIG. 2, the x-axis represents the sampling phase and the y-axis represents the decision threshold.

As discussed before, the BER depends on the power, the sampling phase and the decision threshold. In optical communication systems, signals degrade due to nonlinear effects such as chromatic dispersion, polarization mode dispersion, fiber characteristics and LASER characteristics. The nonlinear effects shift the optimum decision threshold for a sampling phase away from the mid point between the marks and the spaces causing the optimum BER to be difficult to measure. Also, if the required BER is low, it may require a long time to determine the minimum power required at the receiver, which is typically specified during system or equipment calibration. Accordingly, there is a need for a method and system for efficiently determining the minimum power at the receiver in order to achieve a specified BER.

### SUMMARY OF THE INVENTION

The present invention is directed to a method and system for determining a receiver power for a required bit error rate (BER) in optical communication systems. According to one aspect of the invention, a BER contour diagram is created by measuring high BER values and approximating low BER values from the high BER values. The low BER values are approximated using error functions. The optimum decision threshold is determined from the contour diagram and the BER is calculated at the optimum decision threshold. The measured BER is compared to the required or specified BER. If the measured BER is not close to or equal to the required BER, the power at a transmitter is adjusted until the measured BER is close to or equal to the required BER. The receiver power can then be calculated from the transmitter power or directly from the received signal.

### BRIEF DESCRIPTION OF THE DRAWINGS

FIG. 1 illustrates a block diagram of an optical communication system with a BER measurement module.

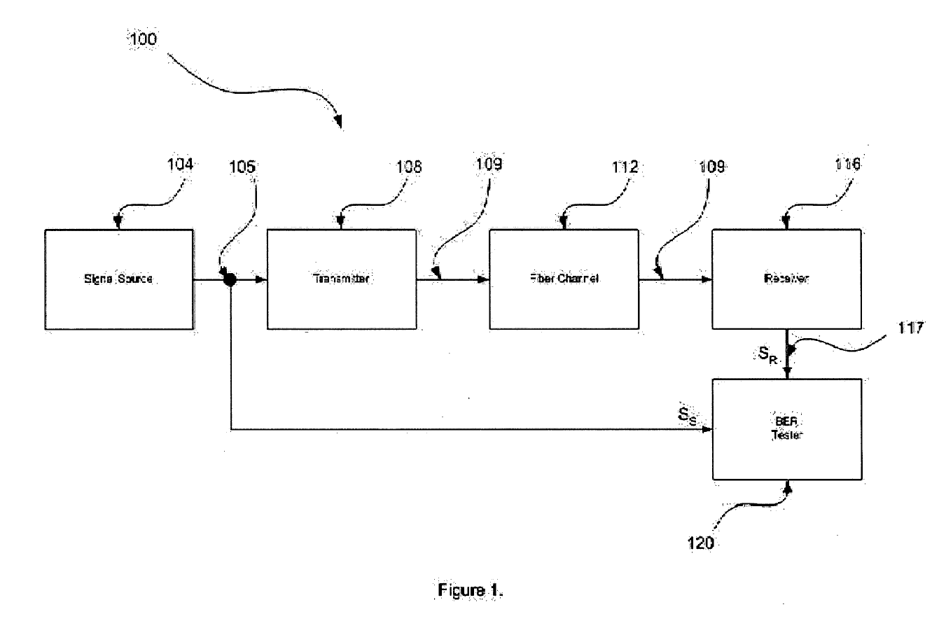

FIG. 2 illustrates a BER contour diagram having a plurality of BER contours.

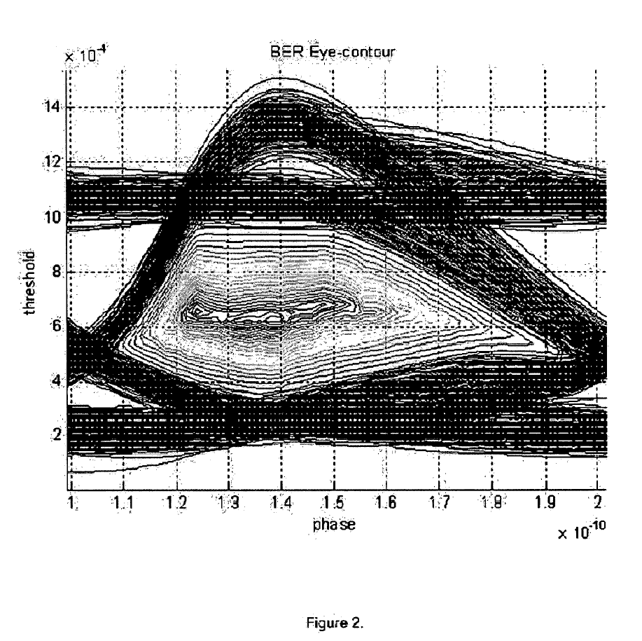

FIG. 3 is a flow diagram of the method steps for determining an optimum decision threshold in accordance with one embodiment of the invention.

FIG. 4 illustrates a simplified block diagram of an optical communication system including a module to determine an optimum decision threshold for a sampling phase in accordance with one embodiment of the invention.

FIG. 5 is a flow diagram of the steps for determining the minimum power at the receiver to achieve a required BER for a receiver sampling phase.

### DETAILED DESCRIPTION OF PREFERRED EMBODIMENTS

In one embodiment of the invention, a BER contour diagram is created to locate the optimum decision threshold for a sampling phase. The BER is measured or calculated at the optimum decision threshold, and the minimum power at the receiver is determined for the BER at the optimum decision threshold.

When BER values are relatively high (e.g., >10e-5), they can be easily measured using selected sampling phases and decision thresholds. However, when BER values are low (e.g., <10e-8), it may require an unreasonably long time to measure the BER. In one embodiment, high BER values are measured, and then, low BER values are approximated from the high BER values to create a BER contour diagram.

When BER is relatively high, it is practical to measure BER at all sampling phases that a receiver may viably sample. The BER measurements may be taken, for example, at decision thresholds close to mark level (e.g., 0.8, 0.9) and space level (e.g., 0.1, 0.2) at all available sampling phases, because measurements close to mark and space levels will likely result in high BER. The sampling phases can be distributed evenly or unevenly. Also the decision thresholds can be distributed evenly or unevenly.

When the decision threshold is set near an optimum level for detection, the BER can be low, and it may take an unreasonably long time to measure the BER. In order to complete the BER contour diagram where the BER is low, an equation provided below representing BER as a function of decision threshold D at a selected sampling phase is used.

$$BER ( D ) = \frac{1}{2} \{ erfc ( \frac{\vert {μ}_{1} - D \vert}{{σ}_{1}} ) + erfc ( \frac{\vert {μ}_{0} - D \vert}{{σ}_{0}} ) \} \qquad ( 3 )$$

Where μ₁ and μ₀ represent the mean of the marks and spaces, respectively, σ₁ and σ₀ represent the standard deviation of the marks and spaces, respectively, and erfc is the complementary error function defined by the following equation:

$$ercf ( x ) = \frac{1}{\sqrt{2 π}} {\int }_{x}^{∞} {ⅇ}^{- \frac{{β}^{2}}{2}} ⅆ β \approx \frac{1}{x \sqrt{2 π}} {ⅇ}^{- \frac{{x}^{2}}{2}} \qquad ( 4 )$$

Equation (3) takes into consideration both the marks and spaces. However, where actual measurements are made for high BER, the decision level D is close to either the mark or the space level, and for those cases, equation (3) is simplified as follows:

$$BER ( D ) = \frac{1}{2} \{ erfc ( \frac{\vert {μ}_{0 , 1} - D \vert}{{σ}_{0 , 1}} ) \} \qquad ( 5 )$$

Next, the logarithm base 10 of equation (5) yields:

$$\begin{matrix}{f ( log ( BER ( D ) ) )}^{- 1} = \frac{{μ}_{1} - D}{{σ}_{1}} \\ \approx 1.192 - 0.6681 ( log 10 ( BER ( D ) ) ) - \\ 0.0162 {( log 10 ( BER ( D ) ) )}^{2} for {μ}_{1} > D \text{?}\end{matrix}$$

$$\begin{matrix}{f ( log ( BER ( D ) ) )}^{- 1} = \frac{D - {μ}_{0}}{{σ}_{0}} \\ \approx 1.192 - 0.6681 ( log 10 ( BER ( D ) ) ) - \\ 0.0162 {( log 10 ( BER ( D ) ) )}^{2} for {μ}_{0} > D \text{?}\end{matrix}$$

$$\text{?} \text{indicates text missing or illegible when filed}$$

The parameters μ₁, μ₀, σ₁ and σ₀ are derived by using a polynomial fit in equations (6a) and (6b). Next, an approximation is used for marks from equation (6a) to obtain equation (7).

$$\frac{{μ}_{1} - D}{{σ}_{1}} = y \qquad ( 7 )$$

Where
y=1.192−0.6681(log 10(BER(D)))−0.0162(log 10(BER(D)))² (8)
The error term is minimized as follows:

$$E = {\sum }_{i = 0}^{n} {( \frac{{μ}_{1} - {D}_{i}}{{σ}_{1}} - {y}_{i} )}^{2} \qquad ( 9 )$$

Where yᵢ is obtained from equation (8) for each decision threshold Dᵢ where BER(Dᵢ) has been measured (BER is high at those decision thresholds). After further modifications, the equations (10) and (11) are obtained.

$$\begin{matrix}{σ}_{1} = \frac{\sum {D}_{i} \sum {D}_{i} - n \sum {D}_{i}^{2}}{n \sum {y}_{i} {D}_{i} - \sum {y}_{i} \sum {D}_{i}} & ( 19 ) \\ {μ}_{1} = \frac{{σ}_{1} ( \sum {D}_{i} \sum {D}_{i} {y}_{i} - \sum {y}_{i} \sum {D}_{i}^{2} )}{\sum {D}_{i} \sum {D}_{i} - n \sum {D}_{i}^{2}} & ( 11 )\end{matrix}$$

Similar equations can be derived for μ₀, and σ₀ where yᵢs and Dᵢs are calculated from the measurements obtained by decreasing the Dᵢs closer to the space level. Once the parameters μ₁, μ₀, σ₁ and σ₀ are obtained, BER(D) can be approximated using equation (3).

The foregoing procedures are repeated for all viable sampling phases and the decision thresholds and the BER values are calculated. The sampling phases and decision thresholds for each specific BER value are plotted to create the BER contour diagrams.

The optimum decision threshold for a sampling phase occurs when the BER due to the marks is equal to the BER due to the spaces. The BERs due to the marks and spaces are equal when equation (6a) is equal to equation (6b).

$$\frac{{μ}_{1} - D}{{σ}_{1}} = {y}_{i} = \frac{D - {μ}_{0}}{{σ}_{0}} \qquad ( 12 )$$

$$D = \frac{{σ}_{1} {μ}_{0} - {σ}_{0} {μ}_{1}}{{σ}_{1} - {σ}_{0}} \qquad ( 13 )$$

The optimum decision threshold and sampling phase is associated to the smallest BER(D) across the BER contour.

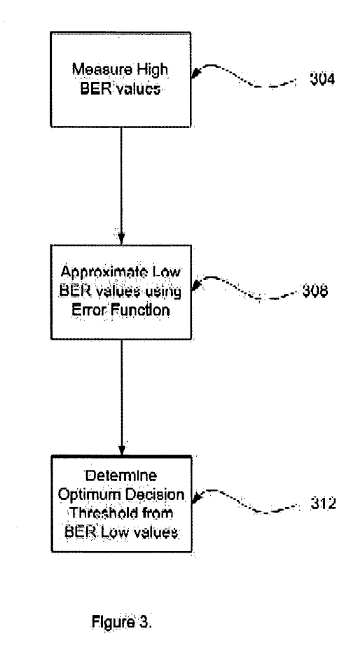

FIG. 3 is a flow diagram of the method steps involved in determining an optimum decision threshold for a sampling phase. In step 304, high BER values are measured using selected sampling phase and decision threshold. In step 308, low BER values are approximated using an error function. In step 312, an optimum decision threshold is calculated from BER corresponding to marks and BER corresponding to spaces.

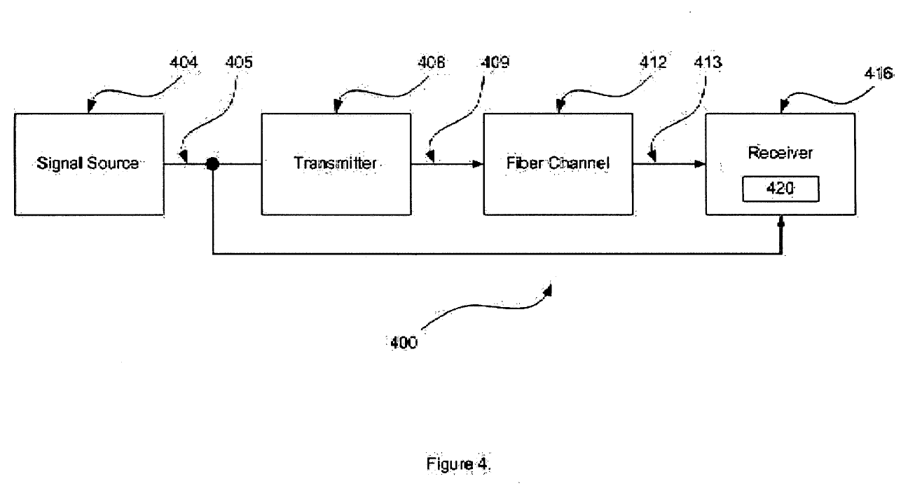

FIG. 4 illustrates a simplified block diagram of an optical communication system 400 including a module to determine an optimum decision threshold for a sampling phase. The system 400 includes a signal source 404 that generates a source signal 405. The signal 405 is received by an optical transmitter 408 and is converted into an optical signal 409. The transmitter 408 transmits the signal 409 over a communication medium such as a fiber channel 412 to a receiver 416. The receiver 416 includes a module 420 that determines optimum decision thresholds for sampling phases using the procedures described above. The module 420 alternatively may reside outside the receiver 416 or may reside inside any other modules in the system 400. The signal source 404 and the transmitter 408 may also reside inside a receiver system such as the receiver 416.

As discussed before, it is desirable to determine the minimum power at the receiver to achieve a required BER. However, it may require a long time to determine the minimum power at the receiver if the required BER is low.

According to one embodiment of the invention, BER is measured by moving the decision threshold closer to the marks and the spaces for each available sampling phase for a given transmitter (TX) power. Next, using the method described above, the optimum decision threshold and sampling phase is determined. If the calculated BER at the optimum decision threshold and sampling phase is less than the required BER, the TX power is decreased. If the measured BER at the optimum decision threshold and sampling phase is greater than the required BER, the TX power is increased. The TX power is varied until the measured BER value is equal to or close to the required BER value. Finally, the corresponding receiver (RX) power is calculated from the TX power or is directly calculated from the receiver signal.

By way of example, suppose the required BER value is 1.0e-15 and the fiber channel attenuation is −30 dB. The TX power is initially set to 5 mW and a BER contour diagram is drawn. The BER is measured corresponding to the optimum decision threshold and sampling phase using the foregoing method. The measured BER corresponding to 5 mW TX power is 1.0e-10.

Since the measured BER (i.e., 1.0e-10) corresponding to TX power=5 mW is higher than the required BER (i.e., 1.0 e-15), the TX power is increased to 7.5 mW. A BER contour diagram is drawn and the BER is measured corresponding to the optimum decision threshold and sampling phase. The measured BER corresponding to 7.5 mW TX power is 1.0e-14.

Since the measured BER (i.e., 1.0e-14) corresponding to 7.5 mW TX power is still higher then the required BER value, the TX power is increased to 8.75 mW and the corresponding BER is measured. The measured BER corresponding to 8.75 mW TX power is 1.0e-18.

Since the measured BER corresponding to 8.75 mW TX power is less than the required BER value, the TX power is now decreased to 8 mW. The measured BER corresponding to 8 mW TX power is 1.5e-15. Since the measured BER value (1.5e-15) at 8 mW TX power is close to the required BER value (1.0e-15), the measured BER value is considered approximately equal to the required BER value.

Next, the RX power is calculated from the TX power (8 mW) using methods well known to those skilled in the art. Since the fiber channel attenuation is −30 dB, the calculated RX power corresponding to 8 mW TX power is 8 uW. Thus, the minimum RX power is set at 8 uW to achieve the required BER value of ≦1.0e-15.

In one embodiment, the invention can be utilized in testing of optical communication devices or systems. For example, during testing of optical communication devices or systems in a test environment such as a laboratory the invention can be used to determine a receiver power for a required BER. It will be obvious to those skilled in the art how to implement the invention during testing of optical communication devices or systems.

In one embodiment of the invention, the receiver power for a required BER can be determined by varying power to the receiver by changing the attenuation of the transmitted signal through the transmission medium (e.g., fiber link or channel) with an optical attenuator rather than changing the TX power. It will be obvious to those skilled in the art how to vary power to the receiver by changing attenuation through the transmission medium with an optical attenuator.

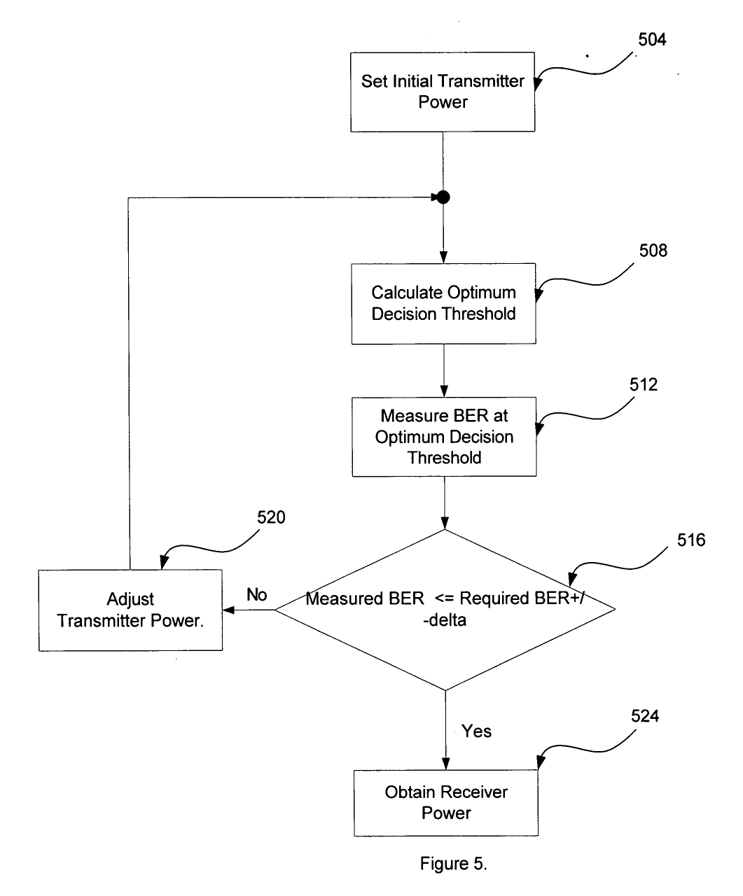

FIG. 5 is a flow diagram of the steps for determining the minimum power at the receiver to achieve a required BER for a particular sampling phase. In step 504, an initial transmitter power is selected. In step 508, the optimum decision threshold is calculated using a BER contour diagram. In step 512, the BER corresponding to the optimum decision threshold is measured or calculated. In step 516 the measured or calculated BER is compared to the required BER. If the measured BER is not equal or close to the required BER, the transmitter power is adjusted in step 520 and the flow returns to step 508 to recalculate the optimum decision threshold using the BER contour diagram. If in step 516 the measured BER is close or equal to the required BER, the flow moves to step 524 wherein the receiver power is calculated from the final transmitter power for a particular sampling phase.

It is to be understood that even though various embodiments and advantages of the present invention have been set forth in the foregoing description, the above disclosure is illustrative only, and changes may be made in detail, and yet remain within the broad principles of the invention. For example, many of the components described above may be implemented using either digital or analog circuitry, or a combination of both, and also, where appropriate, may be realized through software executing on suitable processing circuitry.

What is claimed is:

1. A method for determining a receiver power for a required bit error rate (BER) in an optical communication system, comprising:
transmitting a signal using an initial transmitter power over a transmission medium;
receiving the signal;
measuring high BER values of the optical communication system using the transmitted and received signal, the high BER values being measured using selected sampling phases and decision thresholds, the sampling phase indicating the sampling point in the signal and the decision threshold being a numerical value;
approximating low BER values from the high BER values;
creating the BER contour using the sampling phase and the decision threshold for each BER value;
determining the optimum decision threshold from the BER corresponding to marks and the BER corresponding to spaces, the mark having a value equal to 1 and the space having a value equal to 0;
measuring the BER corresponding to the optimum decision threshold;
if the measured BER is not close to or equal to a required BER, adjusting the transmitter power until the measured BER is close to or equal to the required BER; and
calculating the receiver power from the transmitter power.

2. The method of claim 1 further comprising creating the BER contour diagram using the high and low BER values.

3. The method of claim 2 further comprising determining the BERs due to marks and BERs due to spaces.

4. The method of claim 3 further comprising equating the BERs corresponding to the marks and the BERs corresponding to the spaces to determine the optimum decision threshold.

5. The method of claim 4 further comprising calculating an optimum sampling phase.

6. The method of claim 1 wherein the receiver power for a BER is determined during a testing of a communication system.

7. The method of claim 4 wherein the optimum sampling phase is determined during a testing of a communication system.

8. A system for determining a receiver power for a required bit error rate (BER) in an optical communication system, comprising:
a transmitter configured for transmitting a signal using an initial transmitter power over a transmission medium;
a receiver coupled to the transmission medium and configured to receive the signal;
means for measuring high BER values of the optical communication system using the transmitted and received signal;
means for approximating low BER values from the high BER values;
means for creating a BER contour using the sampling phase and the decision threshold for each BER value;
means for determining the optimum decision threshold from the BER corresponding to marks and the BER corresponding to spaces, the mark having a value equal to 1 and the space having a value equal to 0;
means for measuring the BER corresponding to the optimum decision threshold for each of the sampling phases;
means for determining the optimum sampling phase, the optimum sampling phase being the sampling phase whose optimum decision threshold yields the smallest BER;
means for adjusting the transmitter power until the measured BER is close to a required BER;
means for calculating a receiver power corresponding to the transmitter power.

9. The system of claim 8 further comprising:
means for increasing the transmitter power if the measured BER is higher than the required BER; and
means for decreasing the transmitter power if the measured BER is lower than the required BER.

10. The system of claim 8 wherein the high BER values are measured using selected sampling phases and decision thresholds, the sampling phase indicating the sampling point in the signal and the decision threshold being a numerical value.

11. The system of claim 8 wherein the sampling phase indicates the sampling point in the received signal, and the decision threshold is a numerical value.

12. The system of claim 8 further comprising means for creating the BER contour using the sampling phase and the decision threshold for each BER value.

13. The system of claim 8 wherein the receiver power is determined during a testing of the communication system.

14. A method for determining a receiver power for a required bit error rate (BER) in an optical communication system, comprising:
transmitting a signal using a transmitter power over a transmission medium;
receiving the signal;
measuring high BER values of the optical communication system using the transmitted and received signal, the high BER values being measured using selected sampling phases and decision thresholds, the sampling phase indicating the sampling point in the signal and the decision threshold being a numerical value;
approximating low BER values from the high BER values;
creating the BER contour using the sampling phase and the decision threshold for each BER value;
determining the optimum decision threshold from the BER corresponding to marks and the BER corresponding to spaces, the mark having a value equal to 1 and the space having a value equal to 0;
measuring the BER corresponding to the optimum decision threshold;
if the measured BER is not close to or equal to a required BER, varying the attenuation of the transmission medium until the measured BER is close to or equal to the required BER; and
calculating the receiver power from the transmitter power.

15. The method of claim 14 wherein attenuation of the transmission medium is varied by an optical attenuator.
